(19) United States
(12) Patent Application Publication
(10) Pub. No.: US 2026/0098968 A1
(43) Pub. Date: Apr. 9, 2026

(54) SYSTEM AND METHOD FOR GNSS POSITIONING INTEGRITY BOUNDING

(71) Applicant: Swift Navigation, Inc., San Francisco, CA (US)

(72) Inventors: Philippe Brocard, San Francisco, CA (US); Jan Bolting, San Francisco, CA (US); Alexander Parkins, San Francisco, CA (US); Damien Damien Theureau, San Francisco, CA (US)

(73) Assignee: Swift Navigation, Inc., San Francisco, CA (US)

(21) Appl. No.: 19/354,035

(22) Filed: Oct. 9, 2025

Related U.S. Application Data
(60) Provisional application No. 63/705,441, filed on Oct. 9, 2024.

(51) Int. Cl. G01S 19/20; G01S 19/29

(52) U.S. Cl. CPC G01S 19/20; G01S 19/29

(57) ABSTRACT

A system can include a satellite signal receiver, a computing system, and an optional sensor. The computing system can include a measurement engine, a positioning engine, one or more integrity modules, and an optional combiner. A method can include receiving satellite signals, optionally monitoring the satellite signals, determining a positioning solution, determining an integrity associated with the positioning solution, and optionally operating an external system.

### CROSS-REFERENCE TO RELATED APPLICATIONS

This application claims the benefit of U.S. Provisional Application No. 63/705,441 filed 9 Oct. 2024, which is incorporated in its entirety by this reference.

### TECHNICAL FIELD

This invention relates generally to the GNSS positioning field, and more specifically to a new and useful system and method in the GNSS positioning field.

### BRIEF DESCRIPTION OF THE FIGURES

FIG. 1 is a schematic representation of an example of the system.

FIG. 2 is a flow chart representation of the method.

FIG. 3 is a schematic representation of an example of the system.

FIG. 4 is a schematic representation of an example of the system.

FIG. 5 is a schematic representation of exemplary inputs and outputs from a first integrity module (e.g., a neural network).

FIG. 6 is a schematic representation of exemplary inputs and outputs from a second integrity module (e.g., a set-based algorithm). Note that similar inputs and/or outputs can additionally or alternatively be used by an integrity monitor for monitoring a result from a first integrity module.

FIGS. 7A and 7B are schematic representations of exemplary set-based protection level representations (e.g., showing how the representations could recursively compute the protection level such as by propagating TDCP, wheelticks, IMU, etc. to update the GNSS).

### DETAILED DESCRIPTION

The following description of the embodiments of the invention is not intended to limit the invention to these embodiments, but rather to enable any person skilled in the art to make and use this invention.

### 1. Overview

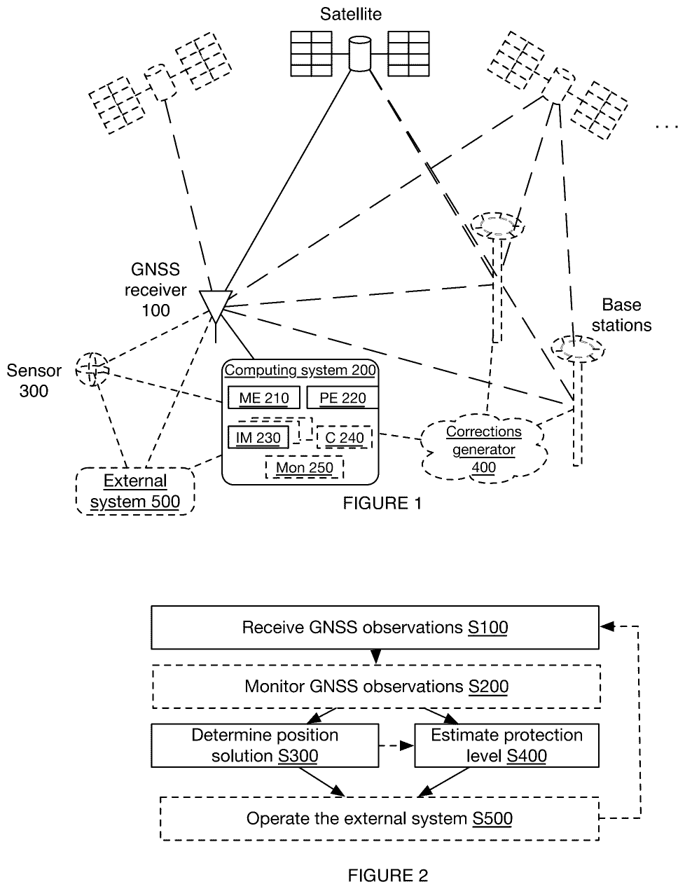

As shown in FIG. 1, a system can include a satellite signal receiver, a computing system, and an optional sensor. The computing system can include a measurement engine, a positioning engine, one or more integrity modules, and an optional combiner. The system can be integrated with (e.g., mounted on) an external system and/or can be freestanding. The system can receive data from one or more data sources (e.g., a corrections generator, one or more reference stations, one or more satellites, etc.).

As shown in FIG. 2, a method can include receiving satellite signals S100, optionally monitoring the satellite signals S200, determining a positioning solution S300, determining an integrity associated with the positioning solution S400, and optionally operating an external system S500.

The system and/or method can function to determine a positioning solution (e.g., of a satellite signal receiver, antenna, external system, etc.), determine an integrity indicator (e.g., a protection level) of the positioning solution, and/or can otherwise function. Embodiments of the system and/or method can be used, for example, in autonomous or semi-autonomous vehicle guidance (e.g., for unmanned aerial vehicles (UAVs), unmanned aerial systems (UAS), self-driving cars, agricultural equipment, robotics, rail transport/transit systems, autonomous trucking, last mile delivery, etc.), GPS/GNSS research, surveying systems, user devices, mobile applications, internet-of-things (IoT) devices, and/or may be used in any other suitable application. In specific examples, the system (and/or components thereof) can be coupled to any suitable external system 500 such as a vehicle (e.g., UAV, UAS, car, truck, etc.), robot, railcar, user device (e.g., cell phone), and/or any suitable system, and can provide positioning data, integrity data (e.g., protection level data), and/or other data to said external system.

### 2. Examples

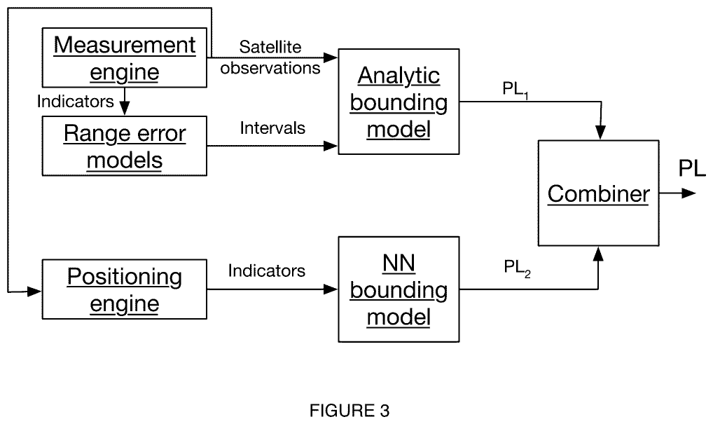

In an example, as shown for instance in FIG. 3, a system can include a measurement engine configured to receive satellite signals and determine satellite observations based on the satellite signals, a first integrity module that receives the satellite observations and indicators (or intervals as determined using a range error model to process the indicators and/or satellite observations) associated with the satellite observations (e.g., corrections bounds, corrections, multipath error models, tracking error models, sensor models, sensor measurements, time-differenced carrier phase measurements, etc.) to determine a first protection level (e.g., using an analytic model such as a set-based model that converts the range-domain information from the satellite observations into a position-domain protection level), a positioning engine configured to determine a position (e.g., positioning solution) of a rover (e.g., satellite signal receiver, antenna, external system, etc.) as well as associated indicators, a second integrity module that receives the indicators from the positioning engine (e.g., positioning solution estimated covariance, dead reckoning time counter, DOP, GDOP, TDOP, HDOP, VDOP, number of satellites in view, signal to noise ratio (C/No), positioning solution residuals, velocity, etc.) and determines a second protection level associated with the positioning solution (e.g., using a neural network or other machine learning algorithm), and a combiner that combines the first and second protection levels to determine a combined protection level associated with the positioning solution (e.g., a maximum protection level, a weighted combination, a fused protection level, other fusion approach, etc.).

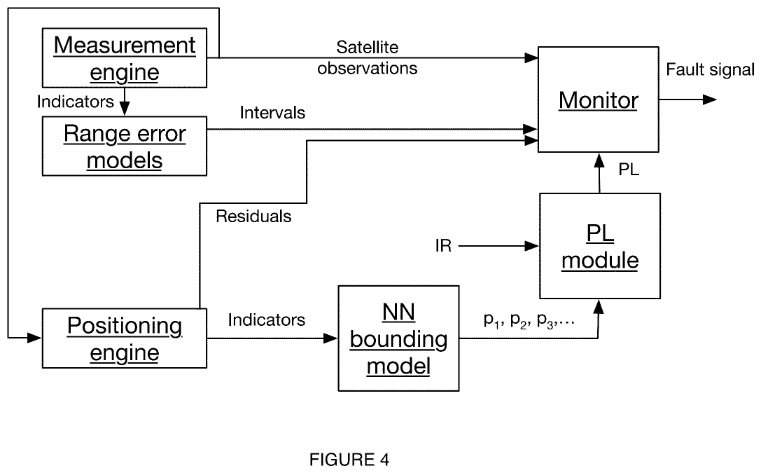

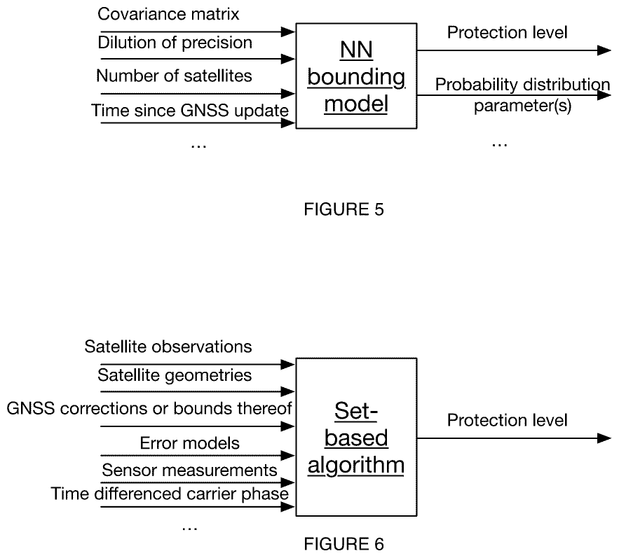

In a second example, as shown for instance in FIG. 4, a system can include a measurement engine configured to receive satellite signals and determine satellite observations based on the satellite signals, a positioning engine configured to determine a position (e.g., positioning solution) of a rover (e.g., satellite signal receiver, antenna, external system, etc.) as well as associated indicators, an integrity module that receives the indicators from the positioning engine (e.g., positioning solution estimated covariance, dead reckoning time counter, DOP, GDOP, TDOP, HDOP, VDOP, number of satellites in view, signal to noise ratio (C/No), positioning solution residuals, velocity, etc.) and determines a conservative position error probability distribution associated with a protection level of the positioning solution (e.g., using a neural network or other machine learning algorithm), and an integrity monitor that receives the satellite observations and/or indicators (or intervals as determined using a range error model to process the indicators and/or satellite observations) associated with the satellite observations (e.g., corrections bounds, corrections, multipath, tracking error models, sensor models, sensor measurements, time-differenced carrier phase measurements, etc.) to monitor (e.g., verify) the probability distribution and/or protection level derived therefrom for a target integrity risk.

### 3. Technical Advantages

Variants of the technology can confer one or more advantages over conventional technologies.

First, variants of the technology can enable a more accurate (e.g., tighter, more representative, closer to the true value, etc., in one or more coordinates) protection level to be achieved. More accurate protection levels can be beneficial for ensuring or providing more accurate knowledge of the probable receiver position and/or a risk that the GNSS receiver (and/or external system) is not where it is expected or supposed to be. For instance, a determined protection level (e.g., the protection level after a final iteration, the protection level after the first iteration, etc.) can be greater than a true protection level by at most about 30% (e.g., 1% greater, 2% greater, 5% greater, 10% greater, 15% greater, 20% greater, 25% greater, values or ranges therebetween, etc.). In a specific example, the more accurate protection levels can be achieved by leveraging machine learning models for determining a protection level and/or by combining a protection level from separate protection level chains that leverage distinct prediction mechanisms (e.g., an analytic model and a machine learning model). However, the determined protection level can be determined with any suitable timing.

However, further advantages can be provided by the system and method disclosed herein.

### 4. System

As shown in FIG. 1, a system can include a satellite signal receiver 100, a computing system 200, and an optional sensor 300. The computing system can include a measurement engine 210, a positioning engine 220, one or more integrity modules 230, an optional combiner 240, one or more optional monitors 250, and/or other suitable components. The system can be integrated with (e.g., mounted on) an external system 500 and/or can be freestanding. The system can receive data from one or more data sources (e.g., a corrections generator, one or more reference stations, one or more satellites, etc.).

The satellite signal receiver preferably functions to receive and track a set of satellite signals from one or more satellites. In variants, the satellite signal receiver (e.g., a computing system thereof, a positioning engine operating thereon, etc.) can determine the location (e.g., by using pseudoranges, by using carrier phase) of the satellite signal receiver (e.g., the satellite signal receiver antenna, the external system, etc.) based on the satellite signals. The satellite signal receiver is preferably in communication with the computing system. However, the satellite signal receiver can be integrated with the computing system (e.g., on the same chip), and/or the satellite signal receiver and computing system can be arranged in any suitable manner. The satellite signal receiver can be a stand-alone device (e.g., including an antenna), integrated into the external system (e.g., be a component of an automobile, aero vehicle, nautical vehicle, etc.), can be a user device (e.g., smart phone, laptop, cell phone, smart watch, etc.), and/or can be configured in any suitable manner.

The set of satellite observations (e.g., determined, derived, etc. from the satellite signals by the measurement engine) can include orbital data, timestamp, range rate data, carrier phase data, pseudorange data, doppler data, and/or any suitable data. The set of satellite observations can be associated with metadata (e.g., ephemeris), and/or any suitable data. The set of satellite observations preferably includes satellite observations corresponding to satellites from more than one satellite constellation (e.g., Global Positioning System (GPS), GLObal Navigation Satellite System (GLONASS), BeiDou positioning System (BDS), Galileo, Navigation with Indian Constellation (NavIC), Quasi-Zenith Satellite System (QZSS), GPS Aided Geo Augmented Navigation (GAGAN), etc.). However, the set of satellite observations can correspond to satellites from a single satellite constellation, can include data from an augmentation system (e.g., Satellite Based Augmentation System (SBAS) such as Wide Area Augmentation System (WAAS), European Geostationary Navigation Overlay Service (EGNOS), Multi-Functional Satellite Augmentation System (MSAS), Omnistar, StarFire, etc.; Ground Based Augmentation Systems (GBAS) such as Local Area Augmentation System (LAAS); etc.), and/or can include any suitable data. Each satellite observation from the set of satellite observations preferably corresponds to a common time window (e.g., epoch). However, each satellite observation can be associated with a timestamp (e.g., time of transmission, time of receipt, time of processing, etc.), and/or the satellite observations can have any suitable timing.

A satellite signal receiver can be configured to receive satellite signals from one or more satellite constellations, one or more carrier frequencies (e.g., the L1, L2, L5, E1, E5a, E5b, Eab, E6, G1, G3, B1, B2, B3, LEX, etc. frequencies), and/or any suitable data. In variants of the system including more than one receiver (e.g., more than one antenna), each receiver can be configured to receive the same and/or different satellite signals (e.g., associated with the same or different satellite constellation(s), the same or different carrier frequency(s), etc.).

The optional sensor(s) 300 preferably function to measure sensor data (e.g., auxiliary data) associated with the external system (and/or the satellite signal receiver). The sensor data is preferably used to determine (e.g., independent of the satellite observations) the external system location, but can additionally or alternatively be used to assist (e.g., speed-up, correct, refine, etc.) the calculation (e.g., calculating the state vector, estimating the phase ambiguity) of position from the satellite observations, propagate a protection level and/or indicator information (e.g., from a generation time to a present time), and/or be otherwise used. The sensors are preferably in communication with the computing system.

The sensors can be: on-board the external system, on-board a separate external system, integrated into the satellite signal receiver, separate from the satellite signal receiver, and/or otherwise associated with the satellite signal receiver.

The sensor data can include: inertial data (e.g., acceleration, angular velocity, angular acceleration, magnetic field, etc.), magnetometry, odometry, pose (e.g., position, orientation), mapping data (e.g., images, point clouds), temperature, pressure, ambient light, images (e.g., thermal images, optical images, etc.; landmarks, features, etc. associated with the images; etc.), video feeds, and/or any other suitable data. The sensors can include one or more of: inertial measurement unit (IMU), inertial magnetometry measurement units (IMMU), accelerometer, gyroscope, magnetometer, odometer (e.g., wheel speeds; wheel ticks; steering angles; visual odometers such as cameras; etc.), pressure sensors, distance measurement instrument, image sensor (e.g., camera, thermal camera, etc.), LIDAR, RADAR, SONAR, and/or any suitable sensor.

The computing system 200 preferably functions to perform the method and/or process the data (e.g., satellite signals, satellite observations, reference station observations, sensor data, etc.) received by the satellite signal receiver(s) and/or the sensor(s). The computing system can: aggregate the data (e.g., combine the satellite signal receiver satellite observations, reference station satellite observations, satellite corrections, and/or sensor data; reorganize the satellite signal receiver satellite observations, reference station satellite observations, and/or sensor data such as based on the timestamp, time of transmission, time of receipt, etc.; etc.), filter the data (e.g., to calculate state vectors, ambiguities such as phase ambiguities, etc. associated with the data), calculate the satellite signal receiver position (e.g., the phase center position), calculate the protection level, calculate the external system location, correct the data (e.g., correct the satellite observations for clock errors, hardware bias, atmospheric effects, etc.), and/or can process the data in any suitable manner. The computing system can be local (e.g., to the external system, to the GNSS receiver, to the sensor, etc.), remote (e.g., cloud computing, server, networked, etc.), and/or otherwise distributed.

The computing system is preferably communicably coupled to the GNSS receiver and/or the sensors, but can be communicably coupled to any suitable data sources. The computing system is preferably colocalized with (e.g., integrated into) the GNSS receiver (and/or external system), but the computing system can be remote from the GNSS receiver (and/or external system), and/or configured in any suitable manner. The computing system can include any suitable processors, microprocessors, graphics processing units, central processing units, memory, field gate programmable arrays, application specific integrated circuits, and/or any suitable components.

In some variants, the computing system can include one or more: measurement engine, positioning engine and/or fusion engine (e.g., filter, particle filter, Kalman filter, extended Kalman filter, unscented Kalman filter, estimator, etc.), integrity module (e.g., protection level calculator, protection level modeler, integrity modeler, alert limit modeler, etc.), monitor (e.g., GNSS monitor, sensor monitor, fault monitor, fault detector, event monitor, event detector, input monitor, protection level monitor, integrity monitor, etc.), error modeler (e.g., functional to define error terms, variances, etc. for consideration such as within the positioning engine or fusion engine, to define an error model, etc., where error terms can include a simple bias such as a linear bias; higher order bias terms such as quadratic, cubic, quartic, quintic, etc.; other error terms such as scale factors, nonorthogonalities, misalignments, multipath errors, tracking errors, etc.; etc.), a classifier (e.g., machine learning algorithm, artificial intelligence, equations, relationships, conditions, look-up table, etc.), a combiner, and/or any suitable components. However, any component (e.g., module, engine, etc.) of the computing system can include and/or perform any suitable algorithm or method. Outputs from any module of the computing system are preferably deterministic (e.g., provide substantially the same result for the same inputs). For example, the modules of the computing system are preferably not updated during runtime (e.g., updated while the system is inactive). However, in some variants, a probabilistic model can be used (e.g., where an additional integrity risk can be allocated to the probabilistic model(s)).

The measurement engine functions to determine satellite observations from the measured satellite signals (e.g., RF signals). The satellite signals can optionally be processed (e.g., filtered, have outliers detected, etc.) prior to and/or within the measurement. For example, the measurement engine can determine a correlation between a satellite signal and a replica of the satellite signal generated in the system to determine the travel time (which is related to the pseudorange and/or carrier phase up to an unknown integer ambiguity between the satellite signal receiver and satellite). In addition to satellite observations, the measurement engine can determine and/or output one or more indicators (e.g., range-domain indicators, measurement indicators, satellite observation indicators, intervals associated with the above, etc.). Examples of measurement indicators include: the presence and/or number of outliers in the data, a satellite dilution of precision (DOP), horizontal dilution of precision (HDOP), vertical dilution of precision (VDOP), time dilution of precision (TDOP), geometric dilution of precision (GDOP), multipath indicator values, tracking error indicators, carrier lock indicators, atmospheric effects, number of satellites in view of the satellite signal receiver, signal to noise ratio (e.g., carrier-to-noise ratio, carrier-to-receiver noise density, energy per bit to noise density, energy per symbol to noise density, modulation error ratio, signal to interference ratio, signal to interference plus noise ratio, signal to quantization noise ratio, contrast to noise ratio, signal strength indicator change, etc.), time since last satellite signal measurement, and/or other suitable indicators (either directly observed or derived from the satellite signals). In some variants, the indicators can be determined (e.g., derived, calculated, estimated, predicted, etc.) from the satellite signals. As a specific example of an indicator that can be determined from the satellite signals, multipath and/or signal to noise ratio can be predicted using a machine learning algorithm (e.g., a neural network trained to determine multipath based on the satellite signal or satellite signal-receiver correlation), can be estimated by more accurately evaluating the correlation shape (e.g., increasing the number of sampling points), using an analytic or empirical relationship (e.g., between the correlation and multipath, between a perceived signal and noise floor, etc.), by generating a metric correlated with the multipath (e.g., using a combination of satellite observations such as code geometry free combination, code-carrier-2*ionosphere combinations, etc.), and/or can otherwise be predicted. In another variant (which can provide a technical advantage by avoiding introduction of errors from combinations of satellite observations such as cycle slips, non-line of sight, etc.), the multipath (and/or tracking) indicator can be determined by computing undifferenced residuals at GNSS rover (e.g., GNSS receiver 100) from precise position and/or broadcast ephemerides, computing residuals at a base or reference station level, estimating (and removing) GNSS rover and base station clock and/or orbit errors, and computing single differences between the rover and the base station, where the single differences can be used as a multi-path indicator. However, other suitable indicators can be determined and/or used.

The positioning engine functions to determine a positioning solution (e.g., position, displacement, speed, velocity, attitude, altitude, acceleration, etc.) of the satellite signal receiver (e.g., external system, antenna, antenna phase center, antenna center of mass, etc.). The positioning engine preferably determines the positioning solution based on the carrier phase measurements (as this can result in a positioning solution estimate with sub meter accuracy). However, the positioning engine can additionally or alternatively use pseudorange, measured doppler (e.g., as described in U.S. patent application Ser. No. 18/415,513 titled ‘SYSTEM AND METHOD FOR FUSING SENSOR AND SATELLITE MEASUREMENTS FOR POSITIONING DETERMINATION’ filed 17 Jan. 2024 which is incorporated in its entirety by this reference), sensor measurements (e.g., the positioning engine can be a fusion engine such as described in U.S. patent application Ser. No. 18/073,304 titled ‘SYSTEM AND METHOD FOR FUSING DEAD RECKONING AND GNSS DATA STREAMS’ filed 1 Dec. 2022 which is incorporated in its entirety by this reference), and/or using any suitable data input(s). The positioning engine can leverage a Kalman filter, extended Kalman filter, unscented Kalman filter, Kalman-Bucy filter, Bierman-Thornton filter, information filter, recursive Kalman filter, Gaussian processes, and/or other suitable state estimators or a particle filter.

Inputs to the positioning engine can include satellite observations (e.g., pseudorange, carrier phase, measured Doppler, etc.), satellite corrections (e.g., spatially invariant corrections such as bias corrections, phase bias corrections, code bias corrections, true bias corrections, clock corrections, orbit corrections, antenna phase bias correction, etc.; spatially variant corrections such as slant total electron count (STEC) corrections, ionospheric gradients, second-order ionospheric delay, tropospheric hydrostatic delays, tropospheric wet delays, etc.; corrections as provided by a corrections service such as described in U.S. patent application Ser. No. 18/210,455 titled ‘SYSTEMS AND METHODS FOR DISTRIBUTED DENSE NETWORK PROCESSING OF SATELLITE POSITIONING DATA’ filed 15 Jun. 2023, U.S. patent application Ser. No. 18/390,747 titled ‘SYSTEM AND METHOD FOR GAUSSIAN PROCESS ENHANCED GNSS CORRECTIONS GENERATION’ filed 20 Dec. 2023, U.S. patent application Ser. No. 18/514,103 titled ‘SYSTEM AND METHOD FOR CORRECTING SATELLITE OBSERVATIONS’ filed 20 Nov. 2023 each of which is incorporated in its entirety by this reference), corrections bounds (e.g., as described in U.S. patent application Ser. No. 18/537,212 titled ‘SYSTEM AND METHOD FOR BOUNDING A SATELLITE POSITIONING SOLUTION INTEGRITY’ filed 12 Dec. 2023 which is incorporated in its entirety by this reference), and/or other suitable information.

Outputs from the positing engine can include: a positioning solution, positioning engine indicators (e.g., covariance matrix, DOP, HDOP, VDOP, TDOP, GDOP, time since last GNSS update, corrections bounds, corrections data, time since last corrections update, age of integrity, signal to noise, residuals, integer fixing mode, integer fixing validation, tracking time, Kalman gain, lock time, cycle slip, etc.), positioning solution residuals, positioning solution errors, and/or other suitable outputs.

In a preferred variant, the positioning engine can: determining the carrier phase ambiguity (e.g., to a floating point precision, to integer precision, to a best integer equivariant, etc. such as disclosed in U.S. patent application Ser. No. 16/817,196 filed 12 Mar. 2020 entitled “SYSTEMS AND METHODS FOR REAL TIME KINEMATIC SATELLITE POSITIONING” or in U.S. patent application Ser. No. 17/022,924 filed 16 Sep. 2020 entitled “SYSTEMS AND METHODS FOR HIGH-INTEGRITY SATELLITE POSITIONING,” each of which is incorporated in its entirety by this reference), determining a set of floating point phase ambiguity hypotheses, determining a set of integer phase ambiguity hypotheses from the set of floating phase ambiguity hypotheses, performing hypothesis testing to resolve the set of integer phase ambiguities hypotheses (e.g., to select the best integer carrier phase ambiguity such as using MLAMBDA, LAMBDA, least-squares ambiguity search technique, etc.), and/or other suitable steps to determine an integer valued carrier phase ambiguity for each satellite observation. In some variations thereof, the integer valued carrier phase ambiguity can be validated in a multi-step validation process (e.g., as described in U.S. patent application Ser. No. 17/022,924 filed 16 Sep. 2020 entitled “SYSTEMS AND METHODS FOR HIGH-INTEGRITY SATELLITE POSITIONING,” which is incorporated in its entirety by this reference; where the step of the validation process can be a positioning engine indicator). In the process of determining the carrier phase ambiguity, the positioning engine can be referred to as operating in a floating-point mode when the carrier phase ambiguities are resolved to a floating point precision and can be referred to as operating in an integer point mode (also called integer fixed mode, fixed mode, etc.) when the carrier phase ambiguities are resolved with an integer-value precision. However, the positioning engine can operate in other mode(s) (e.g., tracked vs untracked mode).

The integrity module(s) preferably functions to determine a protection level (either directly or by determining a quantity associated with the protection level) for the positioning solution as generated by the positioning engine. However, the integrity module(s) can determine or compare other suitable integrity related information. The integrity can include one or more of: position error (e.g., error in the estimated positioning solution such as error in horizontal position of a satellite signal receiver, error in vertical position of a satellite signal receiver, error in pseudorange(s) from a satellite signal receiver to one or more satellites, error in velocity, etc.), integrity risk (e.g., a probability that a position error will exceed a threshold, typically the alert limit, over a period of time), protection level (e.g., a statistical upper bound to position error calculated based on the target integrity risk, a mechanism for real-time position error estimation, an estimated position error assured to meet a given TIR, or P{PE>PL}≤TIR such that the probability of actual position error being larger than the protection level is less than the target integrity risk), alert limit (e.g., a. threshold for the protection level such that when a protection level exceeds the alert limit a flag indicative of such is issued), and time to alert (e.g., an amount of time that may elapse between a protection level surpassing an alert limit and the generation of an alert). However, the integrity of the positioning solution can be defined in terms of other suitable information. In one specific example, the integrity modules as described here can be responsible for faults (e.g., satellite orbit error, satellite clock error, satellite bias error, receiver clock error, receiver bias error, atmospheric delays, etc.) between and age of integrity of GNSS corrections and a current time. However, the integrity modules can be responsible for monitoring faults outside of this time window (e.g., before the age of integrity such as to act as a fail-safe monitor).

Inputs to the integrity module(s) can include: satellite signals, satellite observations, measurement engine indicators, positioning engine indicators, total integrity risk, integrity risk allocation (e.g., for one or more potential faults), corrections engine indicators (e.g., bounds achievable for the corrections which can optionally be updated based on the age of integrity, as described in U.S. patent application Ser. No. 18/491,167 titled ‘SYSTEM AND METHOD FOR DISTRIBUTED INTEGRITY MONITORING’ filed 20 Oct. 2023 which is incorporated in its entirety by this reference, or time since the corrections were generated or tested such as in a manner leveraging sensor data analogous to that described in U.S. patent application Ser. No. 18/798,457 titled ‘SYSTEM AND METHOD FOR COMPUTING POSITIONING PROTECTION LEVELS’ filed 8 Aug. 2024 which is incorporated in its entirety by this reference), age of integrity, dead reckoning counter, multipath (e.g., derived from measurement domain data or position domain data such as using a machine learning algorithm, analytic model, empirical model, etc.), tracking error model, and/or other suitable inputs.

As an illustrative example, a total integrity risk can be 10⁻⁶/hr. This total integrity risk can be allocated to coasting faults (e.g., 10⁻⁷/hr), tropospheric delay errors (e.g., 10⁻⁷/hr), ionospheric delay errors (e.g., 10⁻⁸/satellite/hr), ionospheric residual errors (e.g., 10⁻⁸/hr), hardware (e.g., clock, hardware bias, etc.) faults (e.g., 10⁻⁸/satellite/hr), satellite geometry or orbit errors (e.g., 10⁻⁸/satellite/hr), and/or other suitable error sources or with different allocations to the error sources.

Outputs from the integrity module(s) can include bounds (e.g., protection levels, velocity protection levels, etc. preferably in the position domain), probability distributions (or parameters defining a probability distribution), and/or other suitable information. As a simplified example, a Gaussian probability distribution can be described by two parameters such as the mean and standard deviation. As another illustrative example, parameters for a probability distribution can be coefficients of an expansion (e.g., Taylor series, Fourier series, generalized Fourier series, Airy, power series, orthogonal polynomial series, etc.). However, other suitable parameters can be used. Typically, the probability distribution is a generalization of the protection level that can be used at a variety of different integrity risks to determine the protection level for any value of integrity risk (rather than being tied to a specific integrity risk value). For instance, the probability distribution can be a relationship between a protection level and integrity risk such that the inverse cumulative density function of the estimated distribution can be evaluated at a specific integrity risk to determine the protection level. In another instance, the probability distribution can be a cumulative probability distribution such that the probability distribution can be integrated (up to or down from an integrity risk) to determine a protection level for the integrity risk. However, the protection level (for a given integrity risk) can otherwise be determined (e.g., estimated, derived from, etc.) the probability distribution.

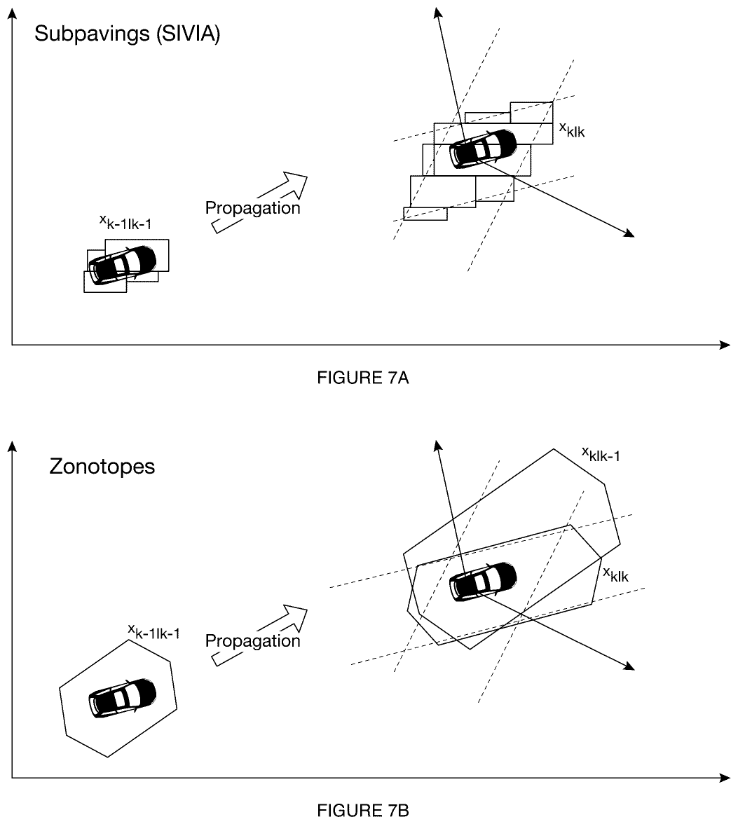

The protection level (directly or indirectly) from the integrity module(s) can be represented as subpavings (e.g., using Set Inverter via Interval Analysis SIVIA to characterize the solution set, as shown for example in FIG. 7A, etc.), zonotopes (as shown for example in FIG. 7B), matrices, and/or using other suitable representations for the protection.

Exemplary integrity modules include: artificial intelligence models (or machine learning models, particularly but not exclusively neural networks), empirical models, analytic models (e.g., set-based algorithms), heuristic models, and/or other suitable models.

The models can include classical or traditional approaches, machine learning approaches, and/or be otherwise configured. The models can include regression (e.g., linear regression, non-linear regression, logistic regression, etc.), decision tree, LSA, clustering, association rules, dimensionality reduction (e.g., PCA, t-SNE, LDA, autoencoder, etc.), neural networks (e.g., FFNN, CNN, DNN, KAN, LSTM, RNN, encoders, decoders, deep learning models, transformers, etc.), ensemble methods, optimization methods, classification, rules, heuristics, equations (e.g., weighted equations, etc.), selection (e.g., from a library), regularization methods (e.g., ridge regression), Bayesian methods (e.g., Naïve Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministic, genetic programs, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of self-attention layers; and/or have any other suitable architecture. In one example, a convolutional neural network with 3 layers can be used. In another example, a convolutional neural network with 10 layers can be used. However, any suitable number of layers can be used. Note that similar considerations also apply when models (e.g., machine learning models) are used for indicator determination (e.g., multipath estimation).

As a specific example, one or more periods of operating a satellite signal receiver (e.g., at different locations such as along drives) can be split into a training and validation dataset. In this specific example, the longer the periods of time covered in the training dataset and/or full dataset, the more likely the protection level estimated using the integrity module can meet or exceed a target integrity risk. As an illustrative example, at least 100 hours of operation data (preferably in a variety of GNSS signal environments) are preferably used to train a model to achieve an integrity risk less than 10⁻²/hr. However, the protection levels can achieve other suitable integrity risk (e.g., less than 10⁻³/hr, less than 10⁻⁴/hr, less than 10⁻⁵/hr, less than 10⁻⁶/hr, less than 10⁻⁷/hr, less than 10⁻⁸/hr, less than 10⁻⁹/hr, etc.). A custom loss function is preferably used to train the model (e.g., as quantile regression is typically not effective in data tails that may be nonGaussian and are often poorly characterized). As an example, a loss function can have a large penalty when a predicted protection level does not bound the positioning error and the loss function can have a smaller penalty related to the magnitude of the protection level (e.g., to provide assurance for availability as otherwise the protection level predicted would almost always be too conservative and issue an alert or flag). As an illustrative example of a loss function, the loss function can be given by

$$f ( , error ) = {α}_{safety} \cdot sm ( {N}_{sample} ) \cdot [ \vert error \vert - + sm ( {N}_{sample} ) \cdot , 0 ] + {α}_{availability} \cdot ,$$

where [symbol] and [symbol] are scaling factors for safety and availability of the protection level respectively, [symbol] is a safety margin that can depend on the number of samples, [symbol] is the protection level, and [symbol] is the magnitude of the position error. For predicting the error distribution, the negative log likelihood of a parametric distribution model such as Generalized Pareto Distribution, Gumbel distribution, Gamma distribution, Gaussian distribution, or other parametric distribution model can be used. However, other loss functions could be used.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data. As a specific example, the training data can include positioning data generated using a plurality of GNSS receivers (e.g., while in motion). The training data preferably can be generated using a single type of GNSS receiver (where an optional model can be used to generalize the results to alternative GNSS receivers) and/or using a plurality of types of GNSS receivers (e.g., different frequencies, models, measurement engines, etc.). Note that similar considerations also apply when models (e.g., machine learning models) are used for indicator determination (e.g., multipath estimation).

In variants that include a plurality of integrity modules, each module preferably injects different inputs (e.g., to facilitate independence of results or outputs from the separate integrity modules). However, additionally or alternatively, different integrity determination approaches can be used by each integrity module of the plurality of integrity modules, and/or a plurality of integrity modules can otherwise be used.

As a specific example, a first integrity module can use a neural network to determine a protection level and/or probability distribution associated therewith from a covariance matrix (of the positioning engine), a dilution of precision (e.g., HDOP, VDOP, etc.), a number of satellites used to determine the GNSS receiver position, a time since the last positioning solution update, a dead reckoning counter, a signal to noise of the satellite signals, a GNSS receiver velocity, and/or residuals from the positioning engine. In this specific example, a second integrity module can use a set-based approach to determine a protection level (or probability distribution associated therewith) from the satellite observations, satellite geometries, GNSS corrections (e.g., for satellite and/or hardware bias, for satellite orbits, GNSS corrections bounds, multi-path error model, tracking error model, time-differenced carrier phase observations, sensor data and/or models, and/or other suitable data. In one variation, the set-based algorithm can determine protection levels using set member state estimators (e.g., Kalman filters, linear squares regression, least squares fitting, etc.).

In some variants, the system can include an integrity monitor that can function to monitor the outputs from one or more integrity modules. In some variants, the integrity monitor can be the same as an integrity module. The integrity monitor preferably operates substantially independently (e.g., uses different data sources, operates on a different processor, etc.) from the integrity modules (or at least the integrity modules to be monitored).

The system can include a plurality of integrity monitors (e.g., to monitor for different faults). For instance, the system can include an integrity monitor such as one described in U.S. patent application Ser. No. 17/940,728 titled ‘SYSTEM AND METHOD FOR SATELLITE POSITIONING’ filed 8 Sep. 2022 which is incorporated in its entirety herein.

As a specific example, an integrity monitor can compare a protection level (either directly computed or derived from the output of an integrity module) with residuals from the positioning engine, bounds from the GNSS corrections (e.g., such as bounds as described in U.S. patent application Ser. No. 18/537,212 titled ‘SYSTEM AND METHOD FOR BOUNDING A SATELLITE POSITIONING SOLUTION INTEGRITY’ filed 12 Dec. 2023 which is incorporated in its entirety by this reference) to ensure that the residuals are consistent with the protection level. When the protection level is consistent, the integrity monitor can output a safe to use flag, no flag, and/or other suitable information indicating that the protection level can be used to meet the integrity risk. When the protection level is not consistent, the integrity monitor can output a flag (e.g., not safe to use, does not meet target, etc.), alert, and/or other suitable information indicating that the protection level cannot be used to meet the integrity risk. However, the integrity monitor can otherwise operate.

The optional combiner functions to combine protection levels determined from integrity modules (in variants that include a plurality of integrity modules). The combiner can determine a most conservative protection level, a least conservative protection level, an intermediate protection level, and/or other suitable protection level can be determined. The combiner can determine the protection level by voting (or otherwise leveraging a machine learning algorithm trained to combine the plurality of protection levels), according to a formula (e.g., weighted average, arithmetic average, geometric average, etc.), according to a ruleset, and/or can otherwise determine the protection level based on inputs from a plurality of input protection levels.

Inputs to the combiner can include protection levels (e.g., a plurality of protection levels), indicators associated with each protection level, and/or other suitable information (e.g., sensor data).

The combiner preferably outputs a protection level (e.g., a single combined protection level). However, the combiner can additionally or alternatively output other suitable information (e.g., confidence interval given a set of assumptions for the output protection level).

As a first specific example of a combiner, the combiner can output the maximum protection level from the plurality of protection levels (e.g., resulting in an optimally conservative protection level but potentially reducing an availability of the positioning solution). As a second specific example of a combiner, the combiner can output a protection level based on consistent logic (e.g., in the absence of potential faults, output a minimum protection level; in the absence of potential faults, output a protection level predicted by a machine learning algorithm; etc. where the combiner can be considered to be acting as an integrity monitor). As a third specific example of a combiner, the combiner can output a protection level based on weighted (or unweighted) average for the plurality of protection levels. As a fourth specific example of a combiner, the combiner can output a protection level scaled by or determined based on a covariance of the positioning solution. As a fifth specific example of a combiner, the combiner can output a protection level based on a safety allocation (e.g., output a protection level derived from an analytic model when a safety allocation for the combiner and/or integrity modules is less than a threshold). As a sixth specific example of a combiner, the combiner can combine decomposed protection levels (e.g., decomposed in a manner analogous to a decomposition as described in U.S. patent application Ser. No. 18/503,662 titled ‘SYSTEM AND METHOD FOR GNSS CORRECTION MONITORING’ filed 7 Nov. 2023 which is incorporated in its entirety by this reference) where different safety allocations can be provided to each of the protection levels (e.g., the integrity modules used to determine the protections associated therewith). However, other suitable combiner(s) can be used.

In some variants the computing system can include a corrections service. Additionally, or alternatively, the computing system can be in communication with a corrections service. The corrections service (e.g., a networked correction service, PPP correction service, PPP-RTK correction service, SSR correction service, RTK correction service, etc.), which can provide corrections (e.g., for spatially invariant corrections such as clock, orbit, hardware bias, etc.; for spatially variant corrections such as ionosphere delay, troposphere delay, etc.; etc. such as those as disclosed in U.S. patent application Ser. No. 17/347,874 filed 15 Jun. 2021 entitled “SYSTEMS AND METHODS FOR DISTRIBUTED DENSE NETWORK PROCESSING OF SATELLITE POSITIONING DATA” and/or U.S. patent application Ser. No. 16/983,706 filed 3 Aug. 2020 entitled “SYSTEM AND METHOD FOR GAUSSIAN PROCESS ENHANCED GNSS CORRECTIONS GENERATION,” each of which is incorporated in its entirety by this reference) for one or more of the satellite observations. In a specific example, the corrections can be provided and/or used as disclosed in U.S. patent application Ser. No. 17/379,271 filed 19 Jul. 2021 entitled “SYSTEM AND METHOD FOR PROVIDING GNSS CORRECTIONS” and/or in U.S. patent application Ser. No. 17/374,523 filed 13 Jul. 2021 entitled “SYSTEM AND METHOD FOR DETERMINING GNSS POSITIONING CORRECTIONS,” each of which is incorporated in its entirety by this reference. In some variations, the computing system can monitor the incoming corrections for predetermined events (e.g., faults), where faults in the corrections can impact the determined protection level.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

### ILLUSTRATIVE EXAMPLES

A numbered list of specific examples of the technology described herein are provided below. A person of skill in the art will recognize that the scope of the technology is not limited to and/or by these specific examples.
1. A system comprising: an antenna configured to receive satellite signals from satellites for global positioning; a positioning engine configured to determine a positioning solution of a body by processing the satellite signals and satellite corrections associated with the satellites for global positioning; a first integrity module configured to determine one or more parameters associated with a probability distribution associated with the positioning solution of the body, wherein the one or more parameters associated with the probability distribution are used to determine a first protection level of the positioning solution; a second integrity module configured to determine a second protection level of the positioning solution independently from the first protection level; and a combiner to combine the first protection level with the second protection level to determine a protection level of the positioning solution.
2. The system of Illustrative example 1, wherein the second integrity module comprises a set algorithm for estimating the second protection level of the positioning solution.
3. The system of any of Illustrative examples 1-2, wherein inputs to the second integrity module comprise: satellite observations determined from the satellite signals; satellite geometries for each satellite of the set of satellites; bounds associated with the satellite corrections; a multi-path error; and a tracking error.
4. The system of any of Illustrative examples 1-3, wherein inputs to the first integrity module comprise a number of the one or more satellites for global positioning; a horizontal dilution of precision; a time since a previous positioning solution was determined; an operation mode of the positioning engine; and a covariance matrix from the positioning engine.
5. The system of any of Illustrative examples 1-4, wherein the first integrity module comprises a convolutional neural network.
6. The system of any of Illustrative examples 1-5, wherein the positioning engine is operable in: a float mode wherein ambiguities in satellite carrier phase are determined using floating point precision; and a fixed mode wherein the ambiguities in the satellite carrier phase are fixed to an integer value.
7. The system of Illustrative example 6, wherein the operating mode of the positioning engine is an input to the first integrity module.
8. The system of any of Illustrative examples 1-7, wherein the probability distribution is a statistical bound to an error in the positioning solution, wherein the statistical bound depends on an integrity risk.
9. The system of any of Illustrative examples 1-8, wherein the combiner determines a maximum of the first protection level and the second protection level, wherein the protection level of the positioning solution is the maximum of the first protection level and the second protection level.
10. The system of any of Illustrative examples 1-9, further comprising an integrity monitor configured to monitor at least one of the second protection level and the one or more parameters associated with the probability distribution.
11. A system comprising: an antenna configured to receive satellite signals from satellites for global positioning; a positioning engine configured to determine a positioning solution of a body by processing the satellite signals and satellite corrections associated with the satellites for global positioning; an integrity module configured to determine one or more parameters associated with a probability distribution associated with the positioning solution of the body; and an integrity monitor configured to verify the probability distribution.
12. The system of Illustrative example 11, wherein the integrity monitor comprises a set algorithm for estimating a first protection level of the positioning solution, wherein the system further comprises a combiner configured to combine the first protection level with a second protection level determined from the probability distribution.
13. The system of Illustrative example 12, wherein inputs to the set algorithm comprise: satellite observations determined from the satellite signals; satellite geometries for each satellite of the set of satellites; bounds associated with the satellite corrections; a multi-path error; and a tracking error.
14. The system of any of Illustrative examples 12-13, wherein the combiner determines a maximum of the first protection level and the second protection level, wherein a protection level of the positioning solution is the maximum of the first protection level and the second protection level.
15. The system of any of Illustrative examples 11-14, wherein the integrity monitor verifies the probability distribution at a given integrity risk based on residuals form the positioning solution.
16. The system of any of Illustrative examples 11-15, wherein the integrity module comprises a convolutional neural network (CNN).
17. The system of Illustrative example 16, wherein inputs to the CNN comprise: a number of the one or more satellites for global positioning; a horizontal dilution of precision; a time since a previous positioning solution was determined; an age of integrity; and a covariance matrix from the positioning engine.
18. The system of any of Illustrative examples 11-17, wherein the positioning engine is operable in: a float mode wherein ambiguities in satellite carrier phase are determined using floating point precision; and a fixed mode wherein the ambiguities in the satellite carrier phase are fixed to an integer value.
19. The system of Illustrative example 18, wherein the operating mode of the positioning engine is an input to the integrity module.
20. The system of any of Illustrative examples 11-19, wherein the probability distribution is a statistical bound to an error in the positioning solution, wherein the statistical bound depends on an integrity risk.
21. A method of operating any system of Illustrative example 1-20.
22. A method for determining a protection level and/or a probability distribution associated with a protection level (e.g., for a plurality of integrity risks) using a machine learning algorithm (e.g., neural network).

We claim:

1. A system comprising:
an antenna configured to receive satellite signals from satellites for global positioning;
a positioning engine configured to determine a positioning solution of a body by processing the satellite signals and satellite corrections associated with the satellites for global positioning;
a first integrity module configured to determine one or more parameters associated with a probability distribution associated with the positioning solution of the body, wherein the one or more parameters associated with the probability distribution are used to determine a first protection level of the positioning solution;
a second integrity module configured to determine a second protection level of the positioning solution independently from the first protection level; and
a combiner to combine the first protection level with the second protection level to determine a protection level of the positioning solution.

2. The system of claim 1, wherein the second integrity module comprises a set algorithm for estimating the second protection level of the positioning solution.

3. The system of claim 2, wherein inputs to the second integrity module comprise:
satellite observations determined from the satellite signals;
satellite geometries for each satellite of the set of satellites;
bounds associated with the satellite corrections;
a multi-path error; and
a tracking error.

4. The system of claim 1, wherein inputs to the first integrity module comprises
a number of the one or more satellites for global positioning;
a horizontal dilution of precision;
a time since a previous positioning solution was determined;
an operation mode of the positioning engine; and
a covariance matrix from the positioning engine.

5. The system of claim 1, wherein the first integrity module comprises a convolutional neural network.

6. The system of claim 1, wherein the positioning engine is operable in:
a float mode wherein ambiguities in satellite carrier phase are determined using floating point precision; and
a fixed mode wherein the ambiguities in the satellite carrier phase are fixed to an integer value.

7. The system of claim 6, wherein the operating mode of the positioning engine is an input to the first integrity module.

8. The system of claim 1, wherein the probability distribution is a statistical bound to an error in the positioning solution, wherein the statistical bound depends on an integrity risk.

9. The system of claim 1, wherein the combiner determines a maximum of the first protection level and the second protection level, wherein the protection level of the positioning solution is the maximum of the first protection level and the second protection level.

10. The system of claim 1, further comprising an integrity monitor configured to monitor at least one of the second protection level and the one or more parameters associated with the probability distribution.

11. A system comprising:
an antenna configured to receive satellite signals from satellites for global positioning;
a positioning engine configured to determine a positioning solution of a body by processing the satellite signals and satellite corrections associated with the satellites for global positioning;
an integrity module configured to determine one or more parameters associated with a probability distribution associated with the positioning solution of the body; and
an integrity monitor configured to verify the probability distribution.

12. The system of claim 11, wherein the integrity monitor comprises a set algorithm for estimating a first protection level of the positioning solution, wherein the system further comprises a combiner configured to combine the first protection level with a second protection level determined from the probability distribution.

13. The system of claim 12, wherein inputs to the set algorithm comprise:
satellite observations determined from the satellite signals;
satellite geometries for each satellite of the set of satellites;
bounds associated with the satellite corrections;
a multi-path error; and
a tracking error.

14. The system of claim 12, wherein the combiner determines a maximum of the first protection level and the second protection level, wherein a protection level of the positioning solution is the maximum of the first protection level and the second protection level.

15. The system of claim 11, wherein the integrity monitor verifies the probability distribution at a given integrity risk based on residuals form the positioning solution.

16. The system of claim 11, wherein the integrity module comprises a convolutional neural network (CNN).

17. The system of claim 16, wherein inputs to the CNN comprise:
a number of the one or more satellites for global positioning;
a horizontal dilution of precision;
a time since a previous positioning solution was determined;
an age of integrity; and
a covariance matrix from the positioning engine.

18. The system of claim 11, wherein the positioning engine is operable in:
a float mode wherein ambiguities in satellite carrier phase are determined using floating point precision; and
a fixed mode wherein the ambiguities in the satellite carrier phase are fixed to an integer value.

19. The system of claim 16, wherein the operating mode of the positioning engine is an input to the integrity module.

20. The system of claim 11, wherein the probability distribution is a statistical bound to an error in the positioning solution, wherein the statistical bound depends on an integrity risk.
